(19) United States
(12) Patent Application Publication
(10) Pub. No.: US 2025/0332600 A1
(43) Pub. Date: Oct. 30, 2025

(54) METHOD, DEVICE, AND NOZZLE FOR APPLYING MEDIUM TO HIGH VISCOSITY LIQUID

(71) Applicant: Shimada Appli G.K., Saitama-shi, Saitama (JP)

(72) Inventor: Takaji SHIMADA, Saitama-shi, Saitama (JP)

(21) Appl. No.: 18/288,281

(22) PCT Filed: Mar. 1, 2023
(86) PCT No.: PCT/JP2023/007535

§ 371 Date: Dec. 27, 2024

(30) Foreign Application Priority Data
Nov. 7, 2022 (JP) 2022-177943

(51) Int. Cl. B05B 1/04; B05B 1/30

(52) U.S. Cl. CPC B05B 1/044; B05B 1/3013

(57) ABSTRACT

Even a fluid having a medium or high viscosity can be uniformly applied to a relatively small target object without scattering, and can be applied separately (selectively applied). A top portion having a hemispherical, pyramidal, or truncated pyramid shape and protruding in a liquid discharge direction is provided at a distal end portion of a tubular nozzle, and a slit is formed in the top portion. A turbulent flow forming member is disposed in a tubular portion of the nozzle. In the turbulent flow forming member, one main channel to which a liquid is supplied and two branch channels branching from the main channel are formed. The liquid flowing out from the two branch channels forms a turbulent flow in a space of the tubular portion and the top portion at the nozzle distal end, and is discharged as a liquid film having a width from the slit at a substantially uniform pressure. The liquid film is applied to a target object at a position before the liquid film is atomized.

### TECHNICAL FIELD

The present invention relates to a method, a device, and a nozzle for applying a medium to high viscosity liquid.

A medium to high viscosity liquid refers to a fluid having a viscosity of approximately 150 centipoise (hereinafter, referred to as “CPS”) or more and about 5000 CPS or less, contains not only a coating material but also a masking material, a moisture-proof material, an insulating material, and a moisture-proof insulating material, and preferably contains a solvent-free liquid as measures of decarbonization and suppression of emission of volatile organic compounds (VOC). In addition, a nozzle used in a coating method and a coating device according to the present invention is an airless nozzle having an elongated slit-like discharge port, and performs coating of a target object with a liquid film portion (film-like liquid portion) discharged from the airless nozzle (so-called film coating).

### BACKGROUND ART

An airless spray nozzle originally atomizes a liquid and coats a target object with the atomized liquid. In a case where there is a portion on which coating is prohibited on a target object (separate coating, or selective coating), it is necessary to mask the portion on which the coating should not be performed. This masking and removal of the mask after the coating are very troublesome work.

In a case where coating is performed on a target object using the airless spray nozzle, if the pressure applied to the liquid to be discharged from the nozzle is slightly reduced, a phenomenon occurs in which a liquid film portion is generated immediately after the discharge from the nozzle and is atomized therebeyond. When this liquid film portion is directly applied to the target object, clear coating of a boundary can be performed. This makes it possible to achieve the separate coating while omitting masking. This method uses a relatively low pressurization pressure, and thus, is suitable for low-viscosity liquids (for example, Patent Literature 1 exemplifies liquids having viscosities of 50 CPS and 100 CPS, Patent Literature 2 exemplifies liquids having viscosities of 50 CPS and 100 CPS, and Patent Literature 4 exemplifies liquids having viscosities of 125 to 155 (144) CPS). These were applied to a relatively small target object such as a printed circuit board (hereinafter, referred to as “PCB”) (a coating width was about 10 mm).

On the other hand, there has been a need for coating using a liquid film portion for coating of a large target object such as coating of an automobile body or coating of a protective film, and an airless nozzle suitable for this has been developed (Patent Literature 6). Patent Literature 6 describes that, as a specific example, a coating width is 80 mm to 330 mm, a nozzle discharge pressure is 0.1 MPa to 1.0 MPa, and a liquid material viscosity is 2000 to 3700 CPS.

### CITATION LIST

### Patent Literature

Patent Literature 1: JP S62-129181 A
Patent Literature 2: JP S62-154794 A
Patent Literature 3: U.S. Pat. No. 4,753,819 (US patent corresponding to Patent Literature 2)
Patent Literature 4: JP 2690149 B
Patent Literature 5: EP 0347058 (European patent corresponding to Patent Literature 4)
Patent Literature 6: JP 5054884 B

In order to meet recent social demands for decarboxylation and suppression of emission of volatile organic compounds (VOC), there is an increasing necessity for coating using solvent-free or low-solvent liquids. These solvent-free or low-solvent liquids have a relatively high viscosity (medium to high viscosity). The airless nozzle described in Patent Literature 6 can be applied to a solvent-free or low-solvent liquid, but the liquid is applied over a wide range at once, which is not suitable for coating of a small target object such as a PCB, particularly a target object having a place that needs to be selectively coated (separate coating).

In order for application to such a small target object, it is conceivable to downsize the airless nozzle described in Patent Literature 6 and narrow a width of a liquid discharge slit opening. Since the viscosity of the liquid that needs to be applied is in the middle or high range, when the nozzle is downsized and the width of the slit is narrowed, a stable liquid film portion cannot be obtained unless the pressure applied to the liquid to be supplied is increased (Patent Literature 6 discloses in [0019] that the nozzle cannot be made too small). If the pressure is further increased, the amount of liquid discharged from the nozzle increases, and a coating film becomes thick. If the width of the slit is further narrowed to suppress the discharge amount, it is necessary to further increase the pressure applied to the liquid. If the pressure is further increased, there are problems that a coating width of the liquid discharged from the nozzle becomes unstable and a boundary is not clearly formed (varies), a large amount of liquid drips easily come out when the nozzle is turned off, and the liquid discharged from the nozzle strongly collides with the target object to splash back and scatter around.

### SUMMARY OF INVENTION

An object of the present invention is to stably apply a liquid film portion to a relatively small target object even in the case of a medium-to-high viscosity liquid. More specifically, variations in a coating width and a coating film thickness can be reduced.

Another object of the present invention is to enable separate coating of a medium-to-high viscosity liquid on a relatively small target object (selective coating according to a place). More specifically, a variation in a coating width can be reduced, and sagging when a nozzle is turned off can be less likely to occur or can be suppressed to a small amount.

Still another object of the present invention is to eliminate or enable reduction of splashing from a target object of a liquid discharged from a nozzle.

A nozzle for applying a liquid film according to the present invention includes: a tubular portion in which a space is formed; a top portion that is continuous with the tubular portion and is provided to protrude in a liquid discharge direction, and has a space that is bilaterally symmetrical with respect to a longitudinal cross section passing through a distal end center of the top portion; and a turbulent flow forming member that is tightly inserted into the tubular portion with a turbulent flow forming space left at least inside the top portion, wherein a slit that is elongated with a constant width is formed in the top portion, the slit passing through the distal end center and having a center line that is a line appearing on a surface of the longitudinal cross section, and a main channel to which a liquid is supplied and a plurality of branch channels branching from the main channel are formed inside the turbulent flow forming member, the main channel is open at a center on an inlet side of the liquid, and the plurality of branch channels are open toward the turbulent flow forming space at symmetrical positions with respect to the center line of the slit.

The nozzle for applying a liquid film according to the present invention can be used in a coating method of a liquid film or a coating device of a liquid film. In this case, the liquid supplied to the nozzle enters the branch channels from the main channel of the turbulent flow forming member disposed in the nozzle, and further enters the turbulent flow forming space from the plurality of branch channels to form a turbulent flow of the liquid. Due to the formation of the turbulent flow, the pressure of the liquid is mainly substantially equalized, and the liquid is discharged in this state from the slit having a constant width in a length direction. Since the slit of the nozzle spreads in the length direction (is long), even a liquid having a medium to high viscosity is discharged from the nozzle while spreading over the entire length of the slit, and thus, a liquid film having a width wider than the entire length of the slit is formed. The liquid film is stably discharged from the slit to be substantially uniform in a width direction and the length direction of the slit, and thus, is directly applied to a surface of a target object. In the coating method of a liquid film or the coating device of a liquid film, a strip-like coating film having a substantially constant width is formed on the surface of the target object when the nozzle is moved at a constant speed in a direction orthogonal to a longitudinal direction of the slit. That is, since the liquid film is stably discharged from the slit, a width of the coating film formed by being applied to the surface of the target object is substantially constant, and a variation in the film thickness is also small. In addition, the pressure applied to the liquid at the time of coating is also relatively low (as compared with a case where there is no turbulent flow forming member), and accordingly, the variation in the coating width can be suppressed to be small, and liquid sagging when the nozzle is turned off is less likely to occur or can be suppressed to be small. Furthermore, the liquid does not vigorously collide with the target object, and thus, the occurrence of splashing can be suppressed or eliminated.

If a valve device that turns on and off the supply of the liquid is provided in the coating gun to which the nozzle is attached, particularly the liquid sagging in the off-state is small, and thus, selective application can be performed.

In a preferred aspect, the space inside the top portion is also a target for a line orthogonal to the center line of the slit, and the plurality of branch channels of the turbulent flow forming member are opened on a line orthogonal to the center line of the slit or at symmetrical positions with respect to the line.

In one aspect, the top portion has a hemispherical shape. In this case, a radius (inner radius) of a hemisphere is desirably less than 2 mm.

In another aspect, the top portion has a conical shape or a truncated cone shape.

In still another aspect, the top portion has a pyramid shape or a truncated pyramid shape.

In a desirable aspect, a width of the slit is 0.1 mm or more and 0.3 mm or less.

More desirably, a ratio of the width to a length of the slit is 1 to 10 or more. More desirably, the ratio is 1:15 or more.

The coating method according to the present invention includes applying a liquid film while moving the above-described nozzle for applying a liquid film at a constant speed in a direction orthogonal to a longitudinal direction of the slit at a height position where a liquid film discharged from the slit of the top portion reaches a surface of a coating target object.

The coating device according to the present invention includes: the above-described nozzle for applying a liquid film; a gun for coating that has a distal end portion to which the nozzle is attached and supplies a liquid to the nozzle; and a robot device that supports the gun for coating and moves the gun for coating at a constant speed in a direction orthogonal to a longitudinal direction of the slit at a height position where a liquid film discharged from the slit of the nozzle reaches a surface of a coating target object.

### BRIEF DESCRIPTION OF DRAWINGS

FIG. 1 is a perspective view illustrating the entire coating system.

FIG. 2 is an enlarged perspective view illustrating a range indicated by a circle E in the coating system in FIG. 1, that is, a state of coating on a surface of a printed circuit mounted substrate.

FIG. 3a is a longitudinal cross-sectional view of a gun for coating, and is a cross-sectional view taken along line a-a in FIG. 3b.

FIG. 3b is a longitudinal cross-sectional view of the gun for coating, and is a cross-sectional view taken along line b-b in FIG. 3a.

FIG. 4a is an enlarged cross-sectional view of the vicinity of a piston in FIG. 3a, and illustrates a state in which a valve (valve device) is turned on.

FIG. 4b is an enlarged cross-sectional view of the vicinity of a nozzle in FIG. 3a, and illustrates a state in which the valve is turned on.

FIG. 5a is an enlarged cross-sectional view of the vicinity of the piston in FIG. 3a, and illustrates a state in which the valve is turned off.

FIG. 5b is an enlarged cross-sectional view of the vicinity of the nozzle in FIG. 3a, and illustrates a state in which the valve is turned off.

FIG. 6a is an enlarged longitudinal cross-sectional view of the nozzle, and is a cross-sectional view taken along line a-a in FIG. 6b.

FIG. 6b is an enlarged longitudinal cross-sectional view of the nozzle, and is a cross-sectional view taken along line b-b in FIG. 6a.

FIG. 7a is a longitudinal cross-sectional view of a turbulent flow forming member.

FIG. 7b is a bottom view of the turbulent flow forming member.

FIG. 8a is a longitudinal cross-sectional view of a nozzle incorporating the turbulent flow forming member, and is a cross-sectional view taken along line a-a in FIG. 8b.

FIG. 8b is a longitudinal cross-sectional view of a nozzle incorporating the turbulent flow forming member, and is a cross-sectional view taken along line b-b in FIG. 8a.

FIG. 8c is a bottom view of the nozzle illustrated in FIG. 8a.

FIG. 8d is a cross-sectional view taken along line d-d in FIG. 8a.

FIG. 9a is a longitudinal cross-sectional view illustrating a state in which a liquid is discharged from the nozzle incorporating the turbulent flow forming member, and is a cross-sectional view taken along line a-a in FIG. 9b.

FIG. 9b is a longitudinal cross-sectional view illustrating a state in which the liquid is discharged from the nozzle incorporating the turbulent flow forming member, and is a cross-sectional view taken along line b-b in FIG. 9a.

FIG. 10a is a cross-sectional view corresponding to FIG. 8a, and illustrates a modification of a nozzle incorporating a turbulent flow forming member.

FIG. 10b is a cross-sectional view corresponding to FIG. 8b, and illustrates the modification of the nozzle incorporating the turbulent flow forming member.

FIG. 11a illustrates another embodiment of a nozzle, and is a cross-sectional view corresponding to FIG. 6a.

FIG. 11b illustrates the another embodiment of the nozzle, and is a cross-sectional view corresponding to FIG. 6b.

FIG. 12a is a cross-sectional view corresponding to FIG. 9a and illustrates a state in which a liquid is discharged from the nozzle illustrated in FIG. 11a incorporating a turbulent flow forming member.

FIG. 12b is a cross-sectional view corresponding to FIG. 9b and illustrates a state in which the liquid is discharged from the nozzle illustrated in FIG. 11b incorporating the turbulent flow forming member.

FIG. 13a illustrates still another embodiment of a nozzle, and is a cross-sectional view corresponding to FIG. 6a.

FIG. 13b illustrates the still another embodiment of the nozzle, and is a cross-sectional view corresponding to FIG. 6b.

FIG. 14a is a cross-sectional view corresponding to FIG. 8a of the nozzle incorporating a turbulent flow forming member of another embodiment.

FIG. 14b is a cross-sectional view corresponding to FIG. 8b of the nozzle incorporating the turbulent flow forming member of the another embodiment.

FIG. 15a is a perspective view of the nozzle illustrated in FIGS. 8a and 8b.

FIG. 15b is a perspective view of the nozzle illustrated in FIGS. 11a and 11b incorporating the turbulent flow forming member.

FIG. 15c is a perspective view of the nozzle illustrated in FIGS. 13a and 13b incorporating the turbulent flow forming member.

FIG. 15d is a perspective view of a nozzle incorporating a turbulent flow forming member and having a top portion formed in a quadrangular pyramid shape.

FIG. 16a is a longitudinal cross-sectional view of a turbulent flow forming member provided with two openings of branch channels.

FIG. 16b is a bottom view of the turbulent flow forming member provided with the two openings of the branch channels.

FIG. 17a is a longitudinal cross-sectional view of a turbulent flow forming member provided with four openings of branch channels, and is a cross-sectional view taken along line a-a in FIG. 17b.

FIG. 17b is a bottom view of the turbulent flow forming member provided with the four openings of the branch channels.

FIG. 18a illustrates a coating film formed by application from the nozzle without the turbulent flow forming member in Experiment 1 (in the case of a scan speed of 300 mm/sec).

FIG. 18b illustrates a coating film formed by application from the nozzle without the turbulent flow forming member in Experiment 1 (in the case of a scan speed of 400 mm/sec).

FIG. 18c illustrates a coating film formed by application from the nozzle without the turbulent flow forming member in Experiment 1 (in the case of a scan speed of 500 mm/sec).

FIG. 19a illustrates a coating film formed by application from the nozzle with the turbulent flow forming member in Experiment 1 (in the case of a scan speed of 300 mm/sec).

FIG. 19b illustrates a coating film formed by application from the nozzle with the turbulent flow forming member in Experiment 1 (in the case of a scan speed of 400 mm/sec).

FIG. 19c illustrates a coating film formed by application from the nozzle with the turbulent flow forming member in Experiment 1 (in the case of a scan speed of 500 mm/sec).

FIG. 20a illustrates a coating film formed by application from the nozzle without the turbulent flow forming member in Experiment 2 (at a scan speed of 300 mm/sec).

FIG. 20b illustrates a coating film formed by application from the nozzle without the turbulent flow forming member in Experiment 2 (at a scan speed of 400 mm/sec).

FIG. 20c illustrates a coating film formed by application from the nozzle without the turbulent flow forming member in Experiment 2 (at a scan speed of 500 mm/sec).

FIG. 21a illustrates a coating film formed by application from the nozzle with the turbulent flow forming member in Experiment 2 (in the case of a scan speed of 300 mm/sec).

FIG. 21b illustrates a coating film formed by application from the nozzle with the turbulent flow forming member in Experiment 2 (in the case of a scan speed of 400 mm/sec).

FIG. 21c illustrates a coating film formed by application from the nozzle with the turbulent flow forming member in Experiment 2 (in the case of a scan speed of 500 mm/sec).

### DESCRIPTION OF EMBODIMENTS

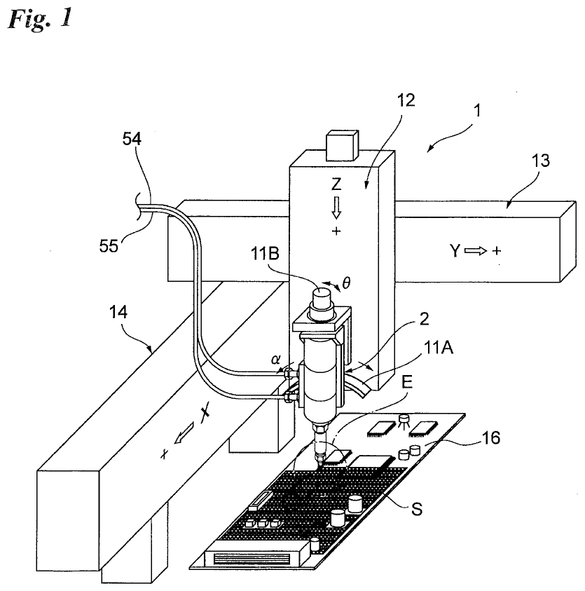

FIG. 1 illustrates the entire coating system (device) according to an embodiment of the present invention.

This coating system is particularly suitable for coating of medium to high viscosity fluids (for example, a solvent-free or low-solvent coating material, a masking agent, a moisture-proof material, an insulating material, a moisture-proof insulating material, and the like), and includes a gun 2 for coating, a robot device (system) 1 that moves the gun 2 for coating along three-dimensional orthogonal axes and rotates the gun 2 for coating about a horizontal axis and a vertical axis, and a platform (not illustrated) for placement of a coating target object (for example, a substrate (mounting substrate) (hereinafter, simply referred to as “PCB”) 16 in which an electronic component and the like are mounted on a printed circuit board. The robot device 1 may be installed on the platform, or the platform may be positioned as a part of the robot device 1.

The robot device 1 includes an a actuator 11A that supports the gun 2 for coating and rotates (turns) the gun 2 for coating about the horizontal axis, a 0 actuator 11B that supports the a actuator 11A and rotates the gun 2 about the vertical axis, a Z-axis actuator 12 that supports the e actuator 11B and moves the gun 2 in the vertical direction (Z direction), a Y-axis actuator 13 that supports and moves the Z-axis actuator in the left-right direction (Y direction) in FIG. 1, and an X-axis actuator 14 that supports and moves the Y-axis actuator 13 in a direction orthogonal to the Y-axis and the Z-axis. The PCB 16 is on an XY plane (a plane perpendicular to the Z axis).

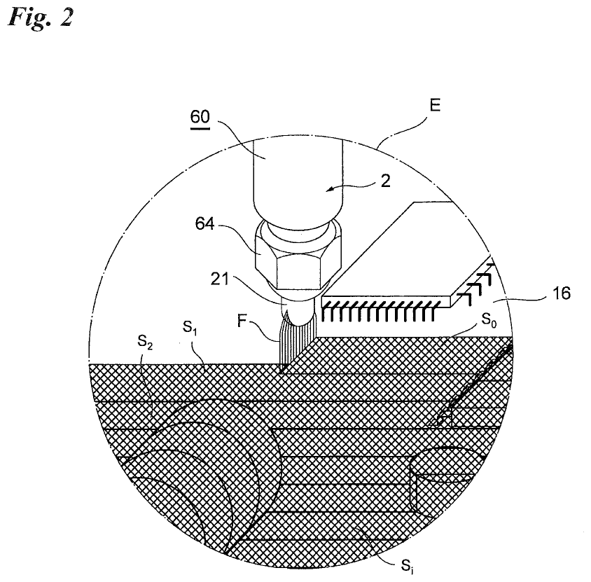

A discharge nozzle 21 (FIG. 2) of the gun 2 for coating supported by the robot device 1 is a so-called airless nozzle (airless coating nozzle or airless application nozzle) for airless spraying a liquid onto a substrate surface of the PCB 16. In the airless spraying, the liquid discharged from a discharge slit (described in detail later) of the nozzle first forms a liquid film portion (film-like liquid portion), and is atomized thereafter. As illustrated in an enlarged manner in FIG. 2, a liquid film portion F abuts on the surface of the PCB 16 as the target object, and the coating of the liquid is achieved (coating without using an atomized portion).

Referring to FIGS. 1 and 2 (particularly, referring to FIG. 2 given in an enlarged manner), the liquid film portion F is discharged in a flat shape (planar shape) from the slit of the nozzle 21. Since the nozzle 21 moves in a direction orthogonal to a planar surface of the liquid film portion F with the movement of the gun 2, the wide liquid film portion F applies the liquid in a strip shape on the surface of the PCB 16. A strip-like coating film formed by the coating is represented by S (FIG. 1), and a coating film currently being formed is indicated by S₀ (FIG. 2). The gun 2 moves in the Y direction at a predetermined height (application height) above the PCB 16, and, when reaching a side portion of the substrate 16, moves in the X direction by a distance slightly shorter than a width of the coating film S and moves in the Y direction in a direction opposite to the previous direction. In this manner, the nozzle 21 coats almost the entire surface (except for both sides and both end portions) of the mounting substrate 16 by continuously moving forward and backward in the Y direction and moving in the X direction at both the end portions. (In FIG. 2, strip-like coating films Sᵢ . . . S₂, S₁, and S₀ are applied in this order). Since a moving distance of the nozzle 21 in the X direction is slightly shorter than a width of the strip-like coating film, the strip-like coating films partially overlap at both side edges thereof (since the strip-like coating film is the liquid, an overlapping portion flows and becomes flat after a while). The nozzle is turned off at both the end portions in the movement in the Y-direction, the coating is temporarily stopped during the movement in the X-direction. In addition, depending on a shape, a size, and the like of the electronic component of the mounting substrate 16, the nozzle is turned off when passing through such a component portion, the coating is stopped, and the coating is not performed on only the portion (selective coating or separate coating). If necessary, the nozzle 21 (gun 2) ascends in the Z direction when passing over the component in order to avoid a collision between the nozzle 21 and the component. In general, the liquid is applied to the entire surface of the electronic component by spot coating, coating from a lateral direction or an oblique direction, or the like at a position of an uncoated portion (there is a case where the uncoated portion is left without being coated).

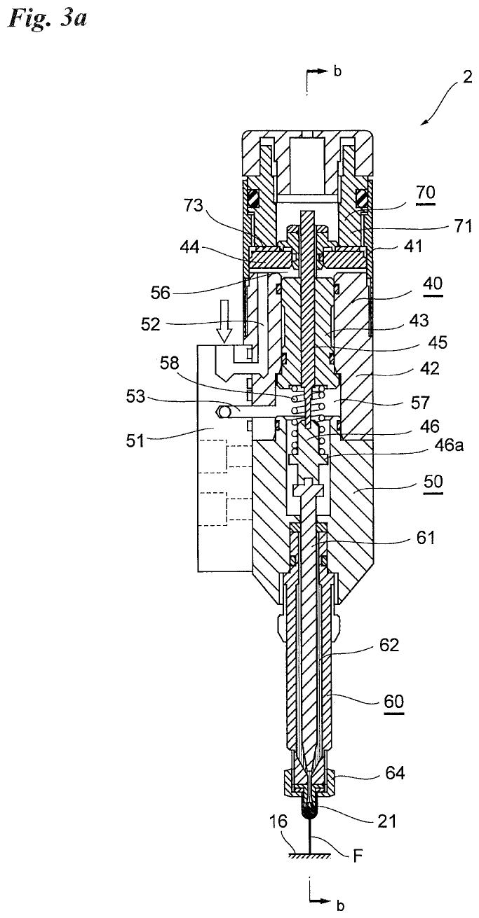

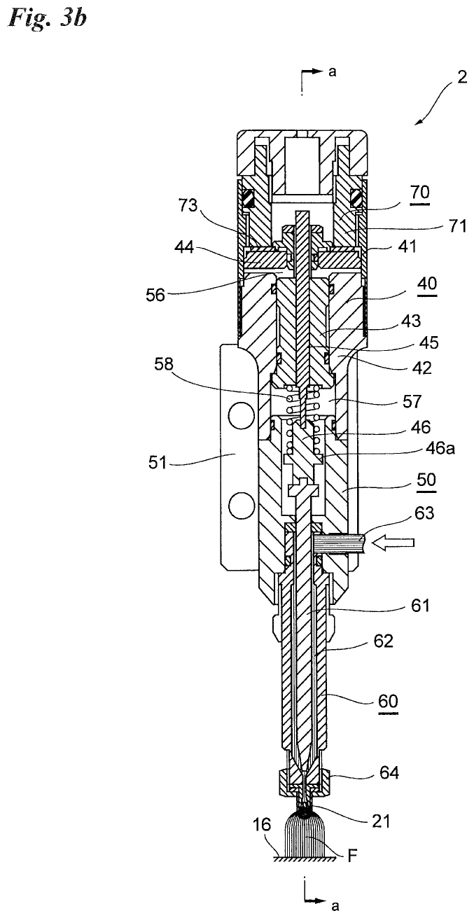

FIGS. 3a and 3b are longitudinal cross-sectional views of the gun 2, and illustrate cross sections passing through the center of the gun 2 and orthogonal to each other. That is, FIG. 3a is a cross-sectional view taken along line a-a of FIG. 3b, and FIG. 3b is a cross-sectional view taken along line b-b of FIG. 3a. The liquid discharged from the nozzle 21 forms the flat liquid film F in the vicinity of a distal end of the nozzle 21, and becomes atomized (mist) thereafter. Only the liquid film F is illustrated and used for the coating.

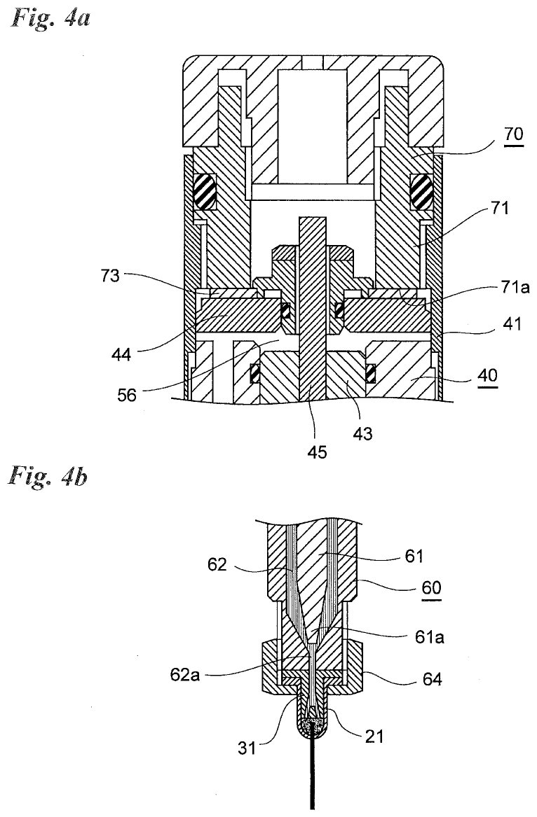

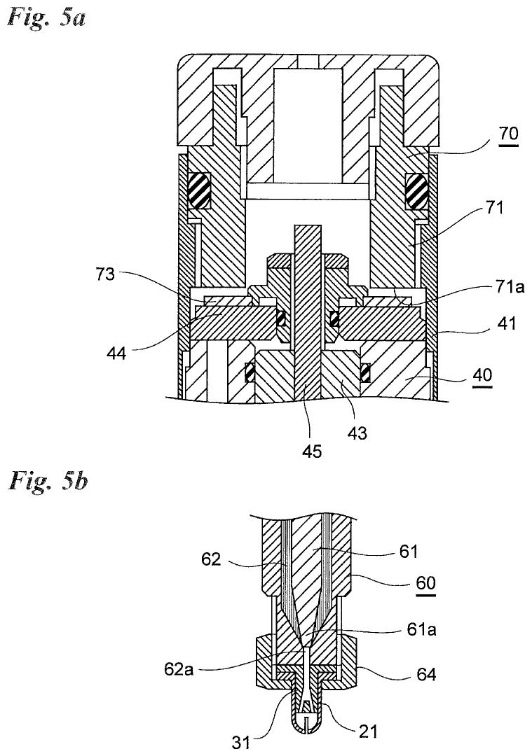

FIGS. 4a and 4b and FIGS. 5a and 5b are partially enlarged views of the gun 2. FIGS. 4a and 4b illustrate a state in which the nozzle 21 is opened (turned on), and the liquid film F is discharged. On the other hand, FIGS. 5a and 5b illustrate a state in which the nozzle 21 is closed (turned off), and the discharge of the liquid film F is stopped. FIGS. 4a and 5a illustrate the vicinity of a piston of an air cylinder device that opens and closes the nozzle, and FIGS. 4b and 5b illustrate a distal end portion of the gun including the nozzle 21.

With reference to these drawings, the gun 2 for coating includes an adjuster 70, an air cylinder device 40, a main body 50, and an extension 60 from above. The main body 50 is attached and fixed to the a actuator 11A by a base 51.

The air cylinder device 40 includes an air inflow and outflow body 42 provided and fixed coaxially with the main body 50 on the main body 50, and a cylinder 41 provided and fixed coaxially with the body 42 on the air inflow and outflow body 42. A piston 44 is disposed inside the cylinder 41, and the piston 44 is airtightly movable up and down along an inner peripheral surface of the cylinder 41. The inside of the body 42 is a cylindrical space, and a lifting and lowering guide member 43 is fixedly disposed with the body 42 in an airtight manner. A pressurization space 56 is provided among a lower surface of the piston 44, the body 42, and the lifting and lowering guide member 43. The pressurization space 56 is connected to an air supply hose 54 (FIG. 1) via an air supply path 52 formed inside the body 42 and the base 51. In addition, a space 57 below the lifting and lowering guide member 43 inside the body 42 is connected to an air flowing hose 55 (FIG. 1) via an air flowing path 53 formed in the body 42 and the base 51.

A connecting rod 45 slidably and airtightly passes through the center axis of the lifting and lowering guide member 43. The connecting rod 45 has an upper end portion that passes through the center of the piston 44 and is fixed to the piston 44, and a lower end portion that is fixedly connected to a needle (needle valve) 61 via an intermediate member 46. The intermediate member 46 is accommodated loosely (to be movable up and down) in a cylindrical space inside the main body 50. The intermediate member 46 is provided with an annular protrusion 46a, and a return spring (compression coil spring) 58 is provided between a lower surface of the guide member 43 and the annular protrusion 46a.

An annular thrust bearing 73 is provided on an upper surface of the piston 44. When compressed air is supplied to the space 56 on the lower side of the piston 44 through the compressed air supply hose 54 and supply path 52, the piston 44 ascends, the thrust bearing 73 on the piston 44 abuts on a stopper portion 71a at a lower end of an adjustment screw 71 of the adjuster 70, and the piston 44 stops ascending at that position. When the piston 44 ascends, the needle 61 ascends via the connecting member 45 and the intermediate member 46, and a distal end 61a thereof separates from a liquid outlet 62a in a lower portion of the extension 60 (the valve is opened) (valve-on) (state in FIGS. 4a and 4b). The return spring 58 is compressed.

When the supply of the compressed air is stopped, a force for lifting the piston 44 stops, so that the return spring 58 stretches to push down the intermediate member 46 (the piston 44 also descends accordingly). When the intermediate member 46 is pushed down, the needle 61 also descends, and the distal end 61a thereof closes the fluid outlet 62a in the lower portion of the extension (the valve is closed) (valve-off) (state in FIGS. 5a and 5b). This is a valve device of the gun 2.

When the adjustment screw 71 of the adjuster 70 is rotated, the stopper portion 71a at the lower end thereof moves up and down to change an upper limit position of the piston 44. As a result, a position of the lower end portion (tip) 61a of the needle 61 changes, so that the degree of opening of the valve can be changed to adjust the discharge amount of the liquid.

The extension 60 is inserted into and fixed to a lower end portion of the main body 50 in the axial direction. Inside the extension 60, a liquid supply path 62 is formed in a cylindrical shape coaxially with the main body 50 and the guide member 43. The liquid supply path 62 is connected to a fluid inlet 63 of the main body 50, and a liquid for coating is supplied from a fluid supply device (not illustrated). The needle 61 passes through a central portion of the liquid supply path 62 with a gap therebetween. Therefore, the liquid passes through an annular space between an inner peripheral surface of the supply path 62 and the needle 61. The liquid supply path 62 has a distal end portion being reduced in diameter in a funnel shape (conical shape) and is continuous with the liquid outlet 62a. The distal end portion 61a of the columnar needle 61 is also tapered toward the tip (in a conical shape). A taper angle of the distal end of the needle 61 (the angle between the center axis and the surface) is smaller (sharper) than a taper angle of the distal end portion of the liquid supply path 62. Therefore, when the needle 61 ascends, the distal end portion 61a thereof is separated from the outlet 62a, and a clearance is formed between the needle and the funnel-shaped portion of the supply path 61. The fluid flows out through this clearance. When the needle 61 descends, the distal end portion 61a closes the outlet 62a, and the outflow of the liquid stops.

The nozzle 21 in which a turbulent flow forming member 31 is accommodated is detachably fixed to a distal end of the extension 60 by a nozzle fixing nut 64. The fluid outlet 62a of the extension 60 and an inlet of the nozzle 21 or the turbulent flow forming member 31 communicate with each another with their centers being aligned with each other.

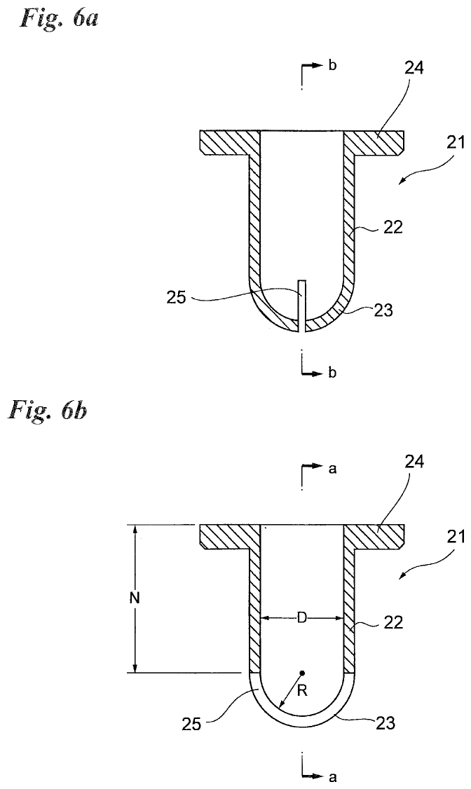

FIGS. 6a and 6b illustrate an example of the nozzle 21.

The nozzle 21 includes a tubular portion 22, a hemispherical top portion (or crown portion) 23 that protrudes in the axial direction from a distal end portion of the tubular portion 22 and is formed to close the distal end portion of the tubular portion 22, and a flange 24 for attachment that is formed to protrude radially outward from a base portion of the tubular portion 22. The tubular portion 22, the top portion 23, and the flange 24 are integrated, and are generally made of metal (for example, high-speed tool steel or stainless steel). At the hemispherical top portion 23, an elongated slit 25 having a constant width is formed along a longitudinal line passing through an apex of the top portion 23. Both ends of the slit 25 extend to a boundary with the tubular portion 22, but may be formed slightly before the boundary without extending to the boundary.

The nozzle 21 is relatively small, and as exemplary dimensions, a diameter (inner diameter) D of the tubular portion 22 is 3.2 mm, a length N is 6.0 mm, and a radius (inner diameter) R of the hemispherical top portion 23 is 1.6 mm. The width of the slit 25 is constant over the entire length (1.6 mm× n, that is, about 5.0 mm) and is 0.2 mm. The width of the slit 25 is preferably about 0.1 mm to 0.3 mm. If a length of the slit 25 is 5 mm, a ratio of the length to the width of the slit is preferably 50 to 1 to 16 to 1. That is, the width of the slit is preferably 1/15 or less of the length of the slit. The width of the slit may be 1/10 or less of the length of the slit. The radius R of the hemispherical top portion 23 is preferably 2.0 mm or less (the length of the slit 25 is about 6.3 mm or less).

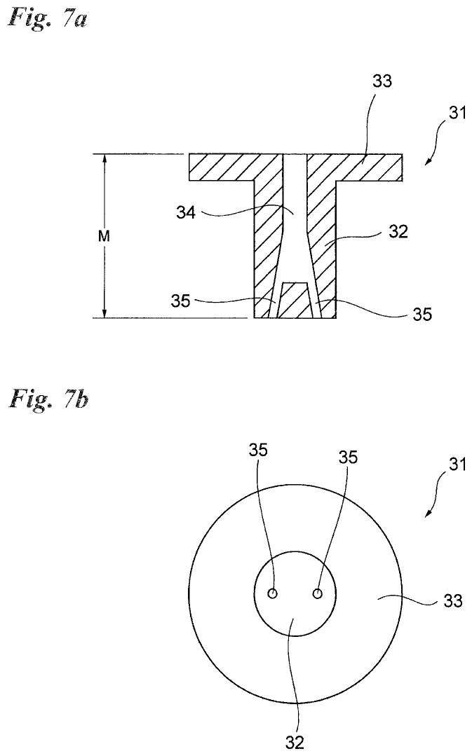

FIGS. 7a and 7b illustrate the turbulent flow forming member 31. The turbulent flow forming member 31 includes a body portion 32 that fits closely into the tubular portion 22 of the nozzle 21, and a flange 33 for attachment that is integrally provided at a base end thereof. In the body portion 32, a main channel 34 that is formed to extend in the axial direction from one end surface on the flange side, and two branch channels 35 that branch from the main channel 34, extend to the other end surface of the body portion 32, and are opened are formed. Inner walls of the channels 34 and 35 are all cylindrical, and as an example, a straight shape of the main channel 34 is 1 mm, and a diameter of the tributary channel 35 is 0.8 mm. A length M of the tubular portion 32 including the flange 33 is 6.0 mm. The turbulent flow forming member 31 is also made of metal (for example, high-speed tool steel or stainless steel).

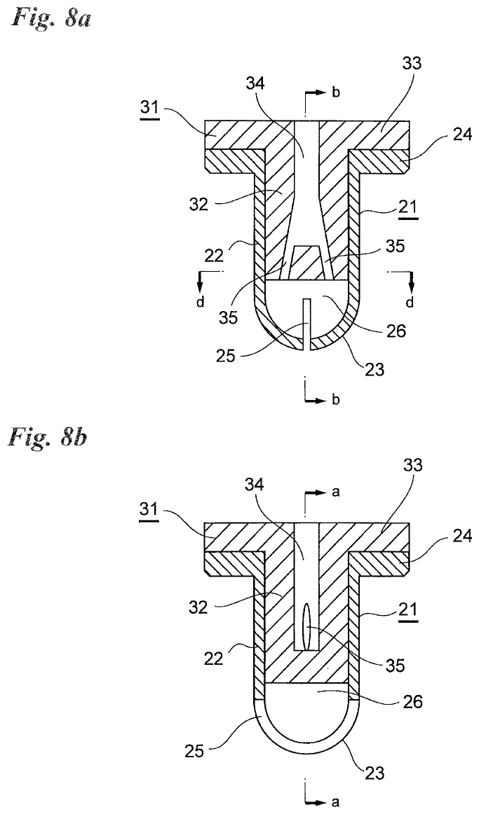

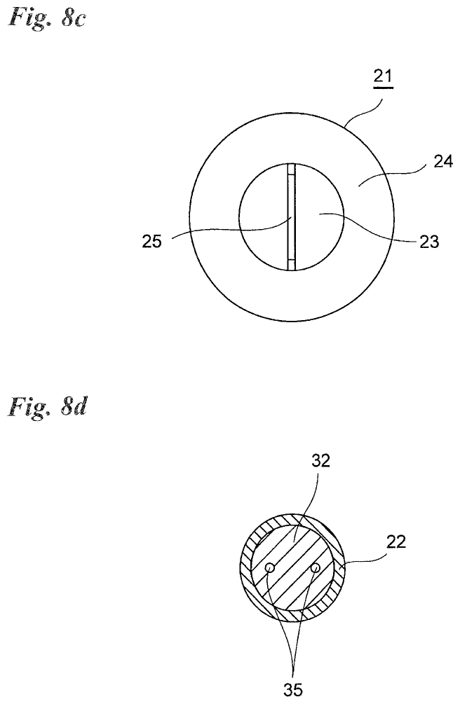

FIGS. 8a, 8b, 8c, and 8d illustrate a state in which the nozzle 21 and the turbulent flow forming member 31 are used in combination.

As described above, in the tubular portion 22 of the nozzle 21, the body portion 32 of the turbulent flow forming member 31 is fitted tightly without any clearance between an inner peripheral surface of the tubular portion 22 and an outer peripheral surface of the body portion 32 of the member 31. The flanges 24 and 33 exactly overlap each other, and as illustrated in FIGS. 4b and 5b in an enlarged manner, the flange 33 abuts on the distal end portion of the extension 60, both the flanges 24 and 33 are tightened by the fixing nut 64, and the nozzle 21 and the turbulent flow forming member 31 therein are attached and fixed to the distal end portion of the extension 60 with their central axes being aligned with each other. In the attached state, the main channel 34 of the turbulent flow forming member 31 is opened at (aligned with) the outlet 62a of the extension 60, and the branch channels 35 are opened to the inside of the top portion of the nozzle 21 (a turbulent flow forming chamber 26).

An angular positional relationship of the turbulent flow forming member 31 with respect to the nozzle 21 is as follows. That is, the two branch channels 35 are opened at line-symmetrical positions with respect to the elongated slit 25 (a straight line passing through the center thereof) (a case in a bottom view of FIG. 8c. It can be understood by combining FIG. 8c and FIG. 8d). In FIGS. 8a and 8b, the turbulent flow forming chamber (a turbulent flow forming space) 26 includes a space inside the distal end portion of the tubular portion 22 of the nozzle 21 and a space inside the top portion 23. Only the space inside the top portion 23 may be used as the turbulent flow forming space.

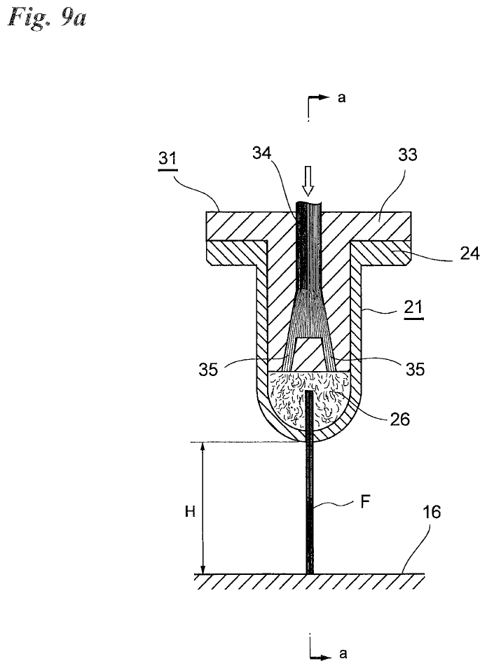

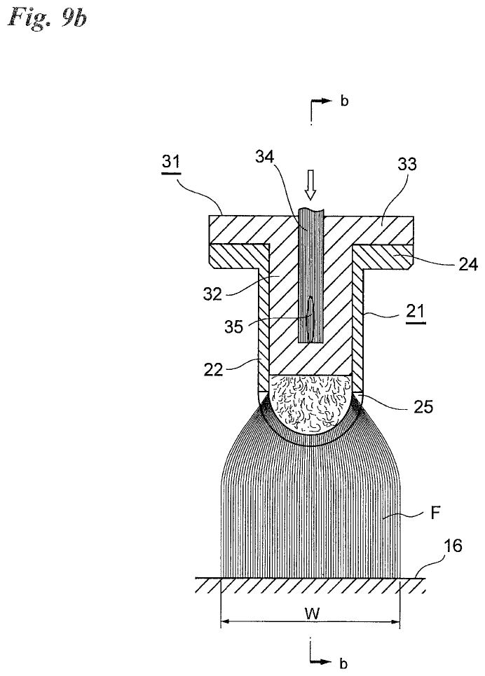

FIGS. 9a and 9b illustrate a state in which a liquid is discharged from the nozzle 21 in which the turbulent flow forming member 31 is incorporated. The liquid flows from the liquid supply path 62 of the extension 60, passes through the outlet 62a, enters the main channel 34 of the turbulent flow forming member 31, further passes through the branch paths 35, and flows into the turbulent flow forming chamber 26 from two openings. Since the two openings of the branch paths 35 are located not directly above the slit 25 but at positions shifted to the side, the liquid emitted from the branch channels 35 form a turbulent flow in the turbulent flow forming chamber 26, and the liquid pressure becomes uniform. The liquid is discharged from the slit 25 in a liquid film state (a state in which the liquid is continuous and spreads in a film shape). As illustrated in FIG. 9a, a width of the liquid film F is substantially constant in a width direction of the slit 25. As illustrated in FIG. 9b, in a length direction of the slit 25, the liquid expands in the length direction of the slit 25 near the slit 25, and then flows substantially straight downward. The width of the liquid film portion F (in the length direction of the slit 25) is denoted by W. The liquid film is atomized thereafter, but when the coating target object (PCB) 16 is placed at a position before the atomization, the fluid is applied onto the target object 16. A height (application height) suitable for such application (height that does not lead to atomization) is denoted by H. H is a distance from the distal end of the nozzle 21 to the target object 16.

As described above, the turbulent flow forming chamber 26 has a hemispherical shape, the branch channels 35 are line-symmetrical with respect to the slit 25, and the width of the slit 25 is constant in the length direction thereof. Therefore, the liquid film F discharged from the slit 25 is substantially homogeneous in the width direction (direction of W) thereof. Therefore, when the nozzle 21 is moved by the robot device 1 in a direction orthogonal to the length direction of the slit 25 with the height H being kept constant, a coating film having a substantially constant width (which will be quantitatively described later for one example) is formed on the target object 16.

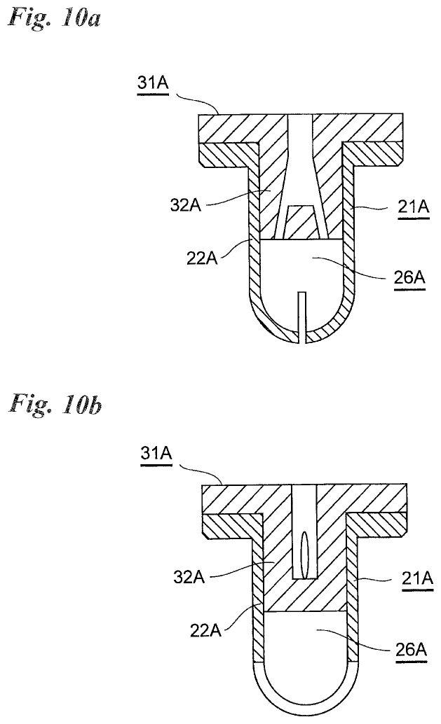

FIGS. 10a and 10b illustrate a modification of a nozzle and a turbulent flow forming member. A length of a tubular portion 22A of a nozzle 21A is longer than that illustrated in FIGS. 8a and 8b, and a length of a body portion 32A of a turbulent flow forming member 31A is shorter than that illustrated in FIGS. 8a and 8b. Therefore, a volume of a turbulent flow forming chamber 26A is larger than that illustrated in FIGS. 8a and 8b. Conversely, a volume of a turbulent flow forming chamber may be reduced by shortening a length of a tubular portion of a nozzle and increasing a length of a body portion of a turbulent flow forming member. Only an internal space at a top portion of a nozzle may be a turbulent flow forming chamber.

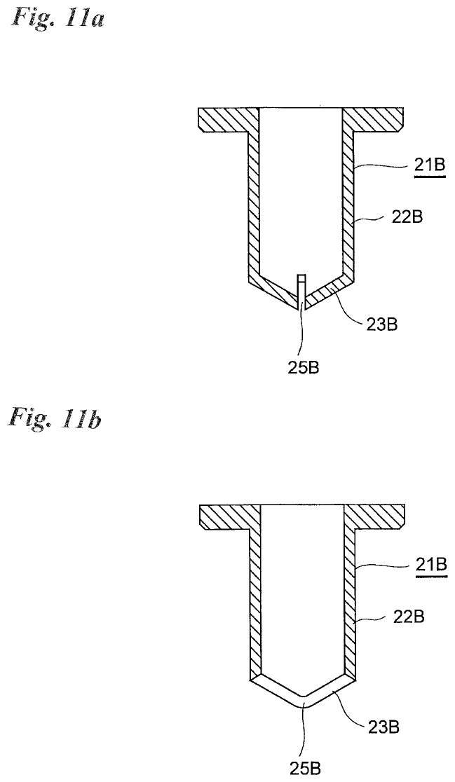

FIGS. 11a and 11b illustrate another embodiment of a nozzle. A top portion 23B of a nozzle 21B is formed in a pyramid shape. The top portion 23B has a conical shape if a tubular portion 22B has a cylindrical shape, and the top portion 23B has a quadrangular pyramid shape if the tubular portion 22B has a prism shape whose cross section has a square shape. A slit 25B is formed with a constant width at a position that passes through an apex of the top portion 23B and divides the top portion 23B to be line-symmetrical with respect to the slit.

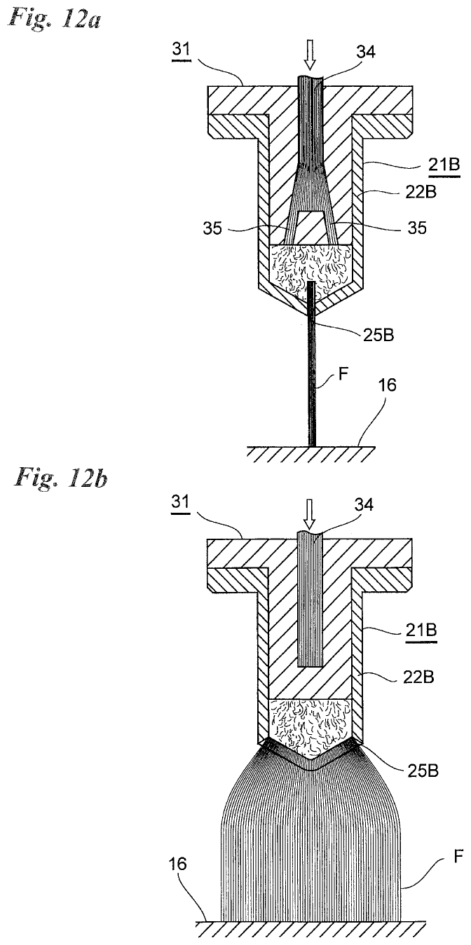

FIGS. 12a and 12b illustrate a state in which the nozzle 22B having the pyramid top portion illustrated in FIGS. 11a and 11b is combined with the turbulent flow forming member 31 illustrated in FIG. 7a and the liquid film F is discharged. Two openings of the branch channels 35 of the turbulent flow forming member 31 are at line-symmetrical positions with respect to the slit 25B. Even in such a combination of the nozzle and the turbulent flow forming member, a coating film having a substantially constant width is obtained by the liquid film F.

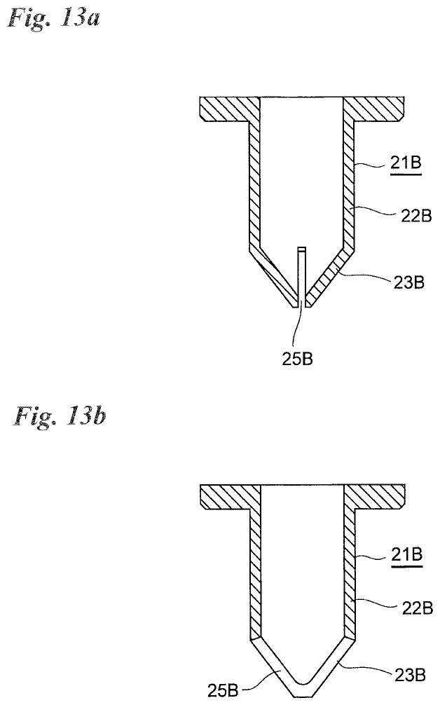

FIGS. 13a and 13b illustrate the nozzle 21B according to a modification in which an angle of a pyramid shape of a top portion is made smaller than that illustrated in FIGS. 11a and 11b.

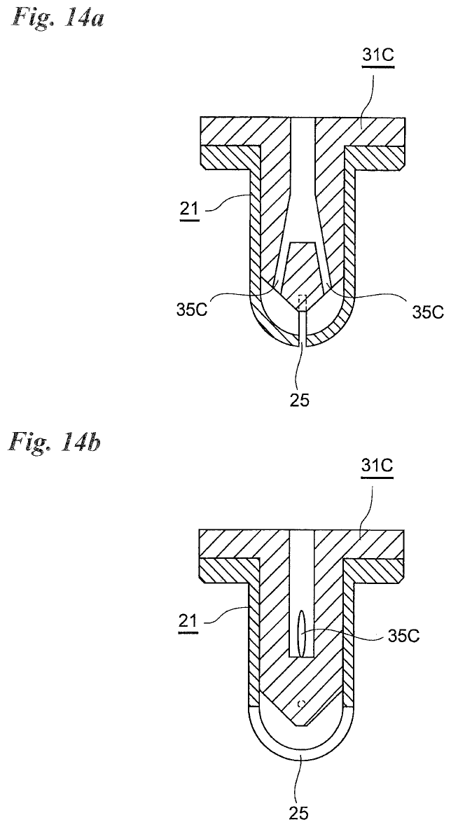

FIGS. 14a and 14b illustrate a modification of a turbulent flow forming member in which a distal end of a body portion has a pyramid shape. In a turbulent flow forming member 31C of this modification, two branch channels 35C are opened on a pyramidal (conical or quadrangular pyramidal) inclined surface. The nozzle 21 illustrated in FIGS. 6a and 6b (or FIGS. 8a and 8b) is combined with the turbulent flow forming member 31C. Openings of branch paths 35C of the turbulent flow forming member 31C are formed at line-symmetrical positions with respect to the slit 25 of the nozzle 21.

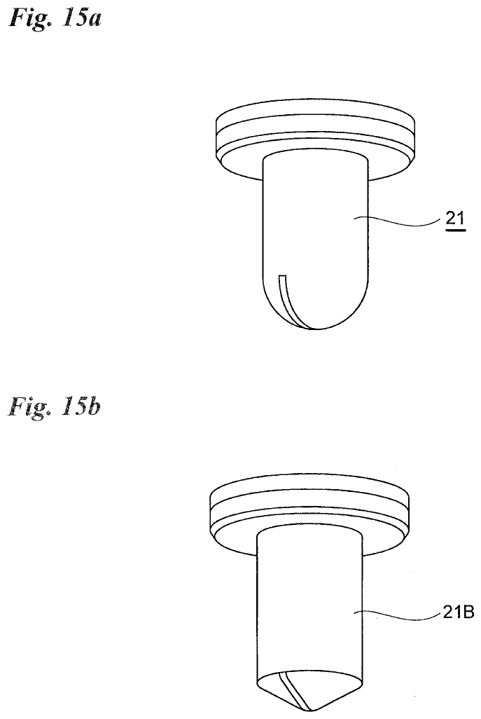

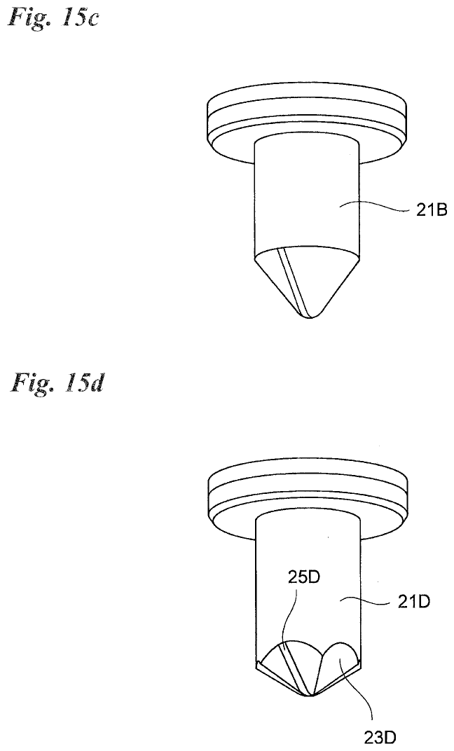

FIGS. 15a to 15d illustrate perspective views of various forms of nozzles combined with a turbulent flow forming member.

FIG. 15a illustrates the nozzle 21 illustrated in FIGS. 8a and 8b (or FIGS. 6a and 6b), FIG. 15b illustrates the nozzle 21B illustrated in FIGS. 11a and 11b (or FIGS. 12a and 12b), and FIG. 15c illustrates the nozzle 21B illustrated in FIGS. 13a and 13b. All tubular portions have a cylindrical shape. FIG. 15d illustrates a nozzle 21D in which a top portion 23D is formed in a quadrangular pyramid shape with four equally shaped inclined surfaces, the nozzle having the cylindrical tubular portion. As illustrated in FIG. 15d, a slit 25D is formed at the center of the inclined surface forming the top portion 23D or at a boundary (ridge line) between adjacent inclined surfaces.

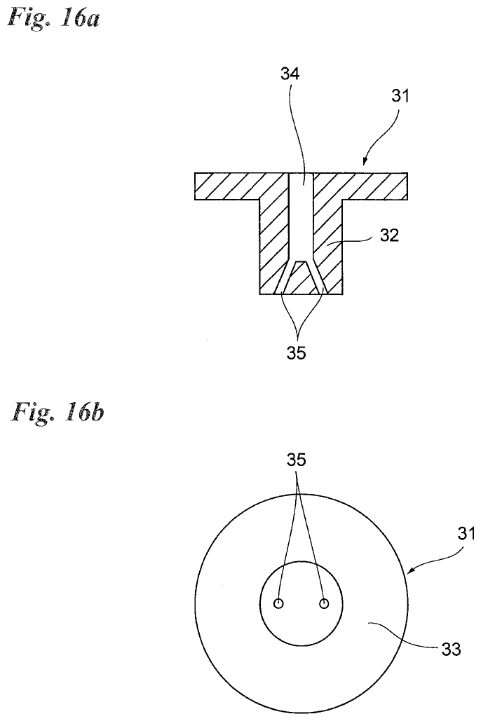

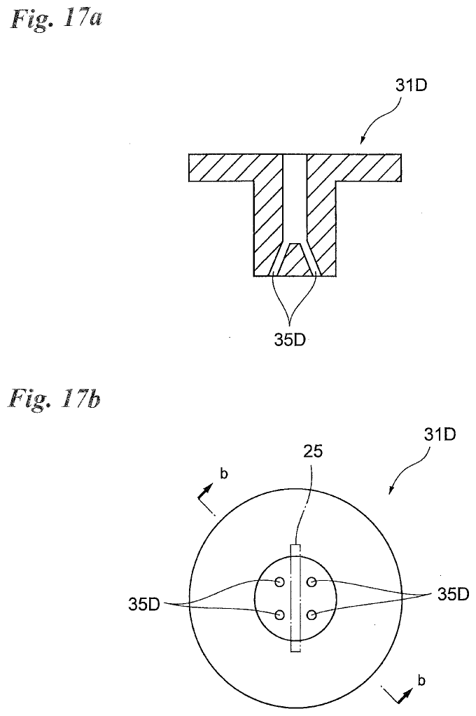

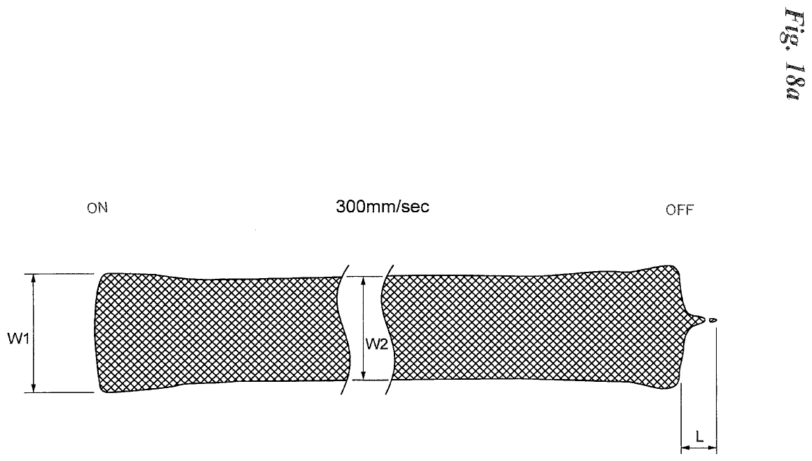

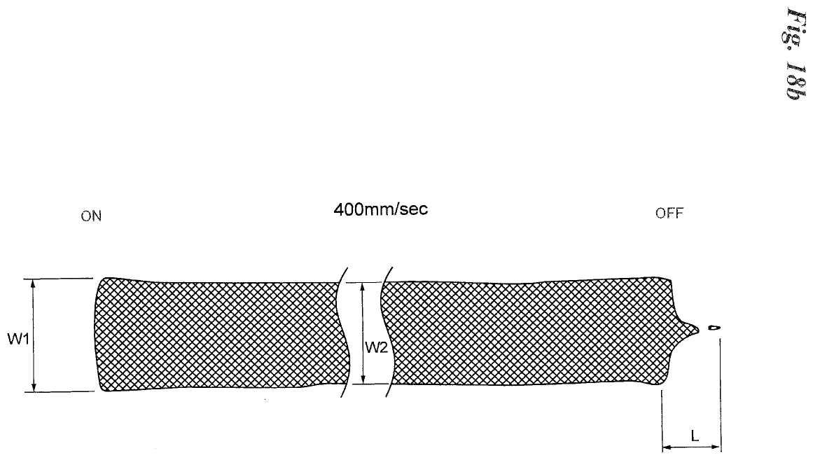

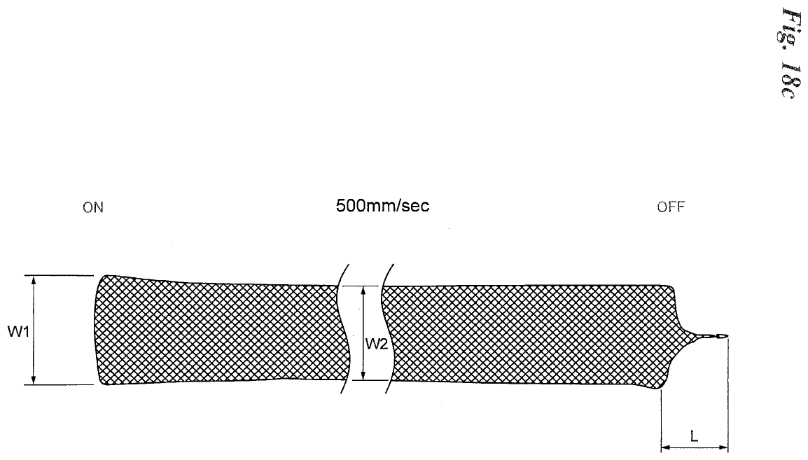

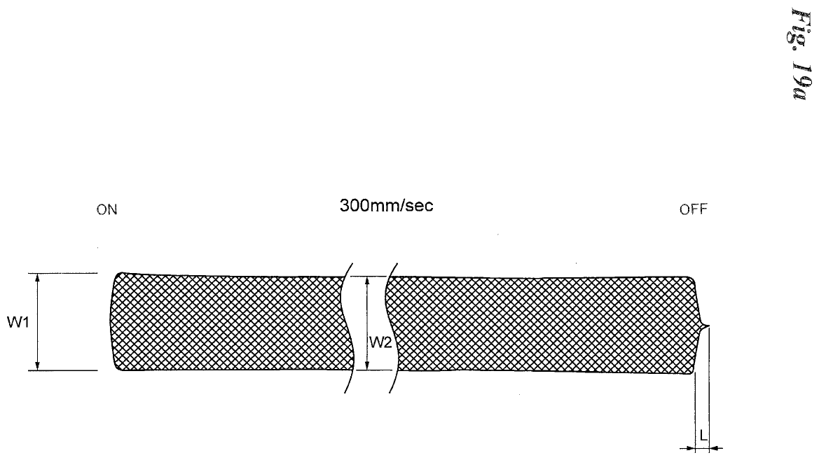

FIGS. 16a, 16b, 17a, and 17b collectively illustrate branch paths of turbulent flow forming members. FIGS. 16a and 16b illustrate the turbulent flow forming member having two branch paths as illustrated in FIGS. 7a and 7b described above. FIGS. 17a and 17b illustrate a turbulent flow forming member 31D having four branch channels 35D. Also in this case, openings of the branch channels 35D are formed at line-symmetrical positions with respect to the slit 25 (indicated by a chain line) of the nozzle.

Finally, experimental results (without the turbulent flow forming member) using the nozzle (whose dimensions are illustrated as an example above) illustrated in FIGS. 6a and 6b are shown. Experimental results (with the turbulent flow forming member) using the nozzle obtained by combining the turbulent flow forming member (the combination illustrated in FIGS. 8a and 8b) illustrated in FIGS. 7a and 7b are also shown.

The application height H indicates a distance (see FIG. 9a) from a nozzle distal end to an application surface of a target object. An application speed is a speed (scan speed) of movement of the gun in the Y direction (direction orthogonal to the length direction of the slit of the nozzle) by the robot. For each application speed, a thickness (film thickness) of a coating film formed on the surface of the target object, the width (coating width) (a maximum width W1 and a minimum width W2), and a length L of liquid sagging (dripping) generated when the nozzle was turned off were measured. Experiments were performed for the case without the turbulent flow forming member (only the application height H of 10 mm) and the case with the turbulent flow forming member (for cases of the application heights H of 10 mm and 15 mm). The liquid pressure means the pressure applied to the liquid to be supplied to the gun. The discharge amount is the discharge amount of the liquid from the nozzle.

### Experiment 1

Coating material: Model Dow Corning 1-2577 as a moisture-proof insulating material having a viscosity of 950 CPS and a type of solvent type silicone (solvent content: 27.7) manufactured by Dow Corning Corporation.

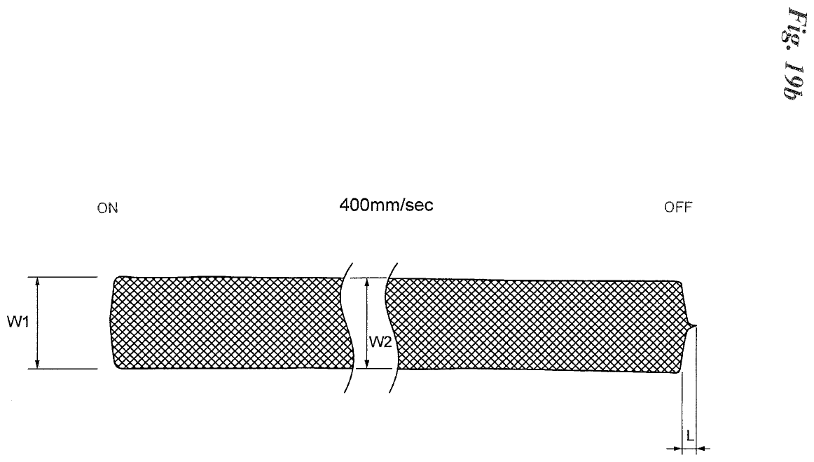

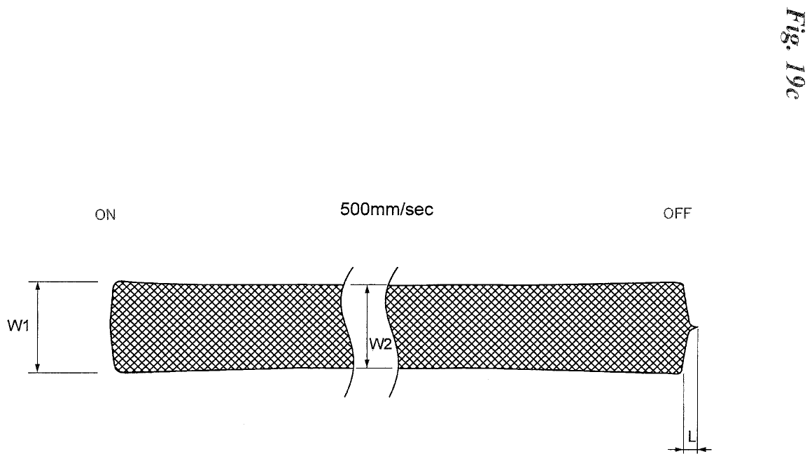

TABLE 1

| | | | | | |
|---|---|---|---|---|---|
| Without turbulent | Application | Application | 300 | 400 | 500 |
| flow forming member | height | speed (mm/sec) | | | |
| Liquid pressure: | 10 mm | Film thickness | 145~166 | 112~125 | 95~110 |
| 540 Kpas | | (μm) | | | |
| Discharge amount: | | Coating width | 15~17.5 | 15~16.5 | 14~16 |
| 45 cc/min. | | (mm) | | | |
| | | Dripping | 6.0 | 9.0 | 9.3 |
| | | length (mm) | | | |
| | | Drawing | FIG. 18a | FIG. 18b | FIG. 18c |

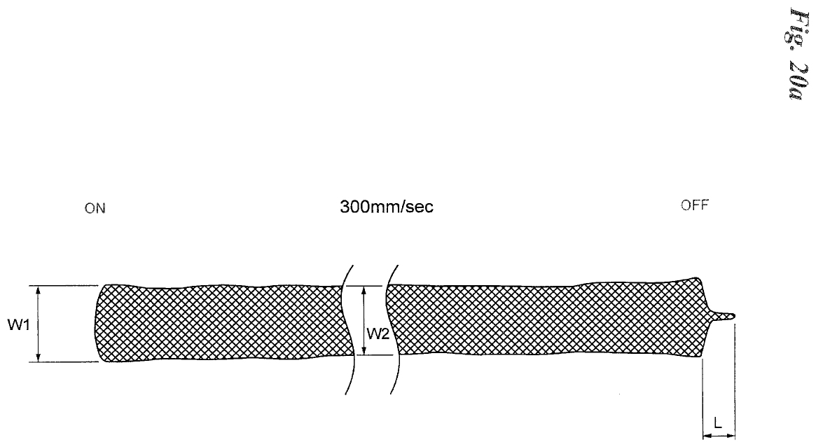

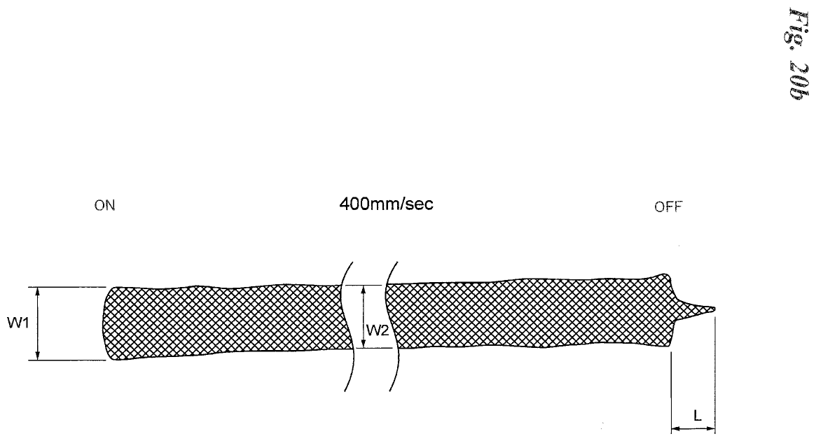

TABLE 2

| With turbulent | Application speed | | 300 | 400 | 500 |
|---|---|---|---|---|---|
| flow forming | (mm/sec) | | | | |
| member Liquid | Application | Film thickness | 146~150 | 116~119 | 95~98 |
| pressure: | height | (μm) | | | |
| 420 Kpas | 10 mm | Coating width | 13.8~13.9 | 13.7~14.3 | 13.1~13.5 |
| Discharge | | (mm) | | | |
| amount: | | Dripping length | 2.7 | 2.8 | 2.8 |
| 39 cc/min. | | (mm) | | | |
| | | Drawing | FIG. 19a | FIG. 19b | FIG. 19c |
| | Application | Film thickness | 127~135 | 97~103 | 89~94 |
| | height | (μm) | | | |
| | 15 mm | Coating width | 16.3~17.3 | 16.0~16.6 | 14.0~14.6 |
| | | (mm) | | | |

### Experiment 2

Coating material: Model 602 MCF-1000 as a moisture-proof insulating material having a viscosity of 1000 CPS and a solvent-free urethane-based UV curing type manufactured by Fuji Chemical Industry Co., Ltd.

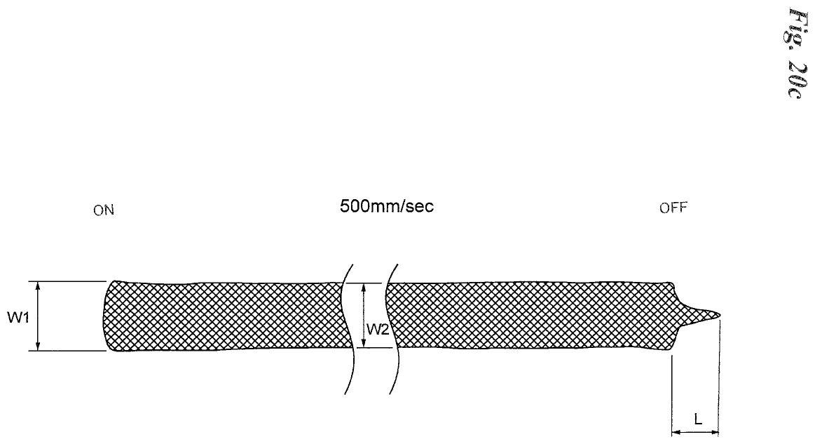

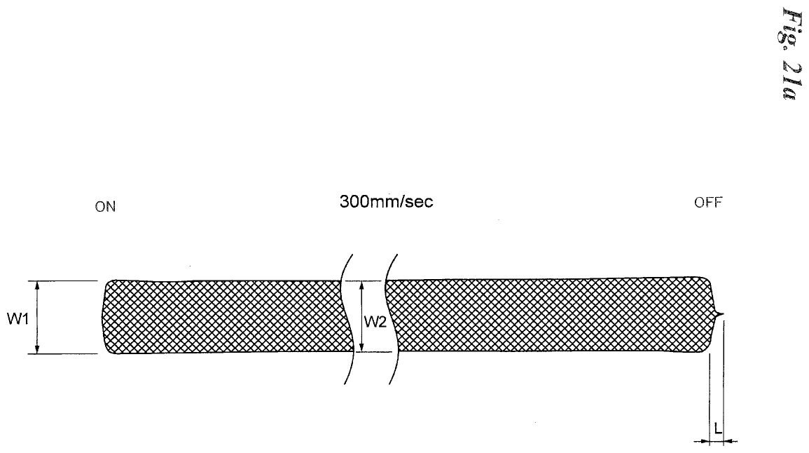

TABLE 3

| | | | | | |
|---|---|---|---|---|---|
| Without turbulent | Application | Application | 300 | 400 | 500 |
| flow forming | height | speed (mm/sec) | | | |
| member | 10 mm | Film thickness | 320~345 | 250~280 | 225~242 |
| Liquid pressure: | | (μm) | | | |
| 780 Kpas | | Coating Width | 10.2~11.2 | 9.2~10.6 | 9.5~10.0 |
| Discharge amount: | | (mm) | | | |
| 65 cc/min. | | Dripping length | 6.0 | 7.5 | 8.1 |
| | | (mm) | | | |
| | | Drawing | FIG. 20a | FIG. 20b | FIG. 20c |

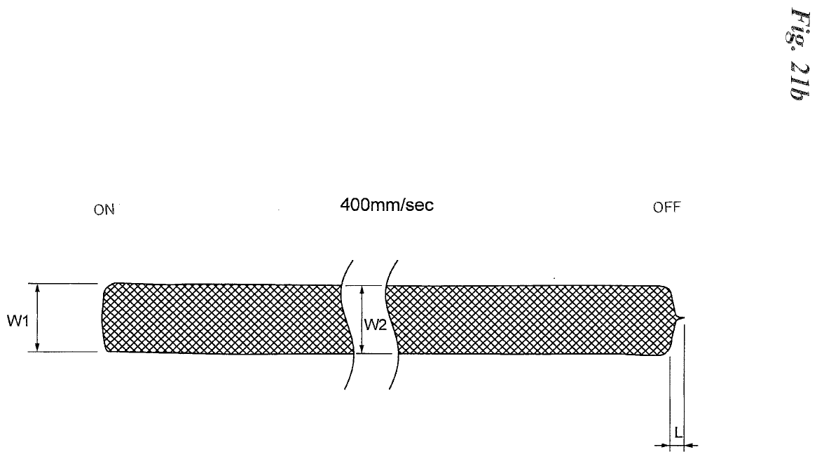

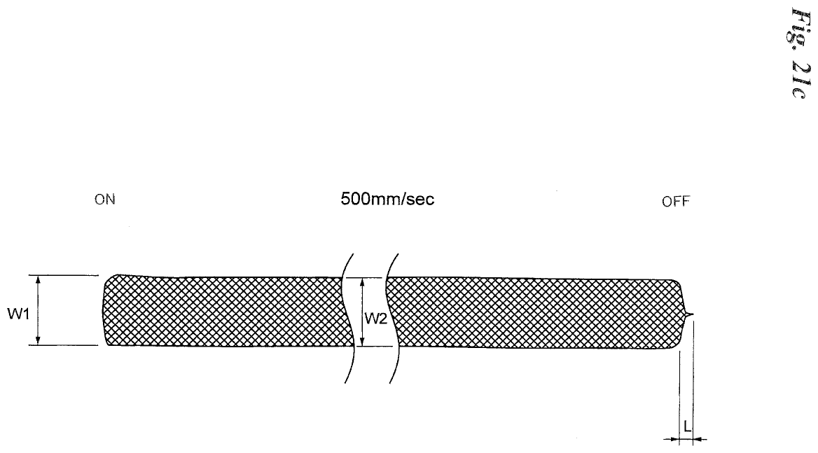

TABLE 4

| With turbulent flow | Application Speed (mm/sec) | | 300 | 400 | 500 |
|---|---|---|---|---|---|
| forming member | Application | Film thickness | 235~245 | 180~188 | 150~156 |
| Liquid pressure: | height | (μm) | | | |
| 440 Kpas | 10 mm | Coating width | 10.3~10.7 | 10.0~10.2 | 10.0~10.2 |
| Discharge amount: | | (mm) | | | |
| 45 cc/min. | | Dripping length | 2.7 | 3.2 | 3.0 |
| | | (mm) | | | |
| | | Drawing | FIG. 21a | FIG. 21b | FIG. 21c |
| | Application | Film thickness | 214~225 | 164~170 | 137~141 |
| | height | (μm) | | | |
| | 15 mm | Coating width | 10.4~10.7 | 11.3~11.5 | 11.0~11.1 |
| | | (mm) | | | |

As can be seen from Tables 1 to 4 and FIGS. 18a to 21c, stable liquid application is possible due to the presence of a turbulent flow forming member in both Experiment 1 and Experiment 2. That is, regarding the coating width, a variation in the coating width (a difference between the maximum width W1 and the minimum width W2) is around 10% or more in the case without the turbulent flow forming member, whereas a variation in the coating width is suppressed to less than 5% in the case with the turbulent flow forming member. In the case with the turbulent flow forming member, a variation in a coating thickness is also suppressed to around 5%. Furthermore, the length L of liquid sagging when the nozzle is turned off is extremely short in the case where the turbulent flow forming member is provided (there is also a case where the length L of liquid sagging is shorter than ⅓ of that in the case without the turbulent flow forming member). In the case with the turbulent flow forming member, the liquid pressure (pressurization pressure) decreases and the discharge amount decreases as compared with the case without the turbulent flow forming member. The decrease in the liquid pressure is considered to contribute to a decrease in the variation in the film width and film thickness of the coating film and a decrease in the liquid sagging length when the nozzle is off. Coating that is excellent in all respects is achieved by providing the turbulent flow forming member. Although not illustrated in the experimental results (drawings), it has been visually recognized that the occurrence of splashing of the liquid was eliminated or reduced.

### REFERENCE SIGNS LIST

1 robot device
2 gun for coating
16 printed circuit board (PCB) (coating target object)
21, 21A, 21B, 21D nozzle
22, 22A, 22B tubular portion
23, 23B, 23D top portion
24 flange
25, 25B, 25D slit
26, 26A turbulent flow forming chamber (space)
31, 31A, 31C, 31D turbulent flow forming member
32, 32A tubular portion
33 flange
34 main channel
35, 35C, 35D branch channel
40 air cylinder
41 cylinder
44 piston
47 return coil spring
50 main body
60 extension
61 needle
61a needle distal end portion
62a outlet
64 nozzle fixing nut
F liquid film
S, S₀, S₁, S₂, Sᵢ coating film

1. A nozzle for applying a liquid film, comprising:
a tubular portion in which a space is formed;
a top portion that is continuous with the tubular portion and is provided to protrude in a liquid discharge direction, and has a space that is bilaterally symmetrical with respect to a longitudinal cross section passing through a distal end center of the top portion; and
a turbulent flow forming member that is tightly inserted into the tubular portion with a turbulent flow forming space left at least inside the top portion,
wherein a slit that is elongated with a constant width is formed in the top portion, the slit passing through the distal end center and having a center line that is a line appearing on a surface of the longitudinal cross section, and
a main channel to which a liquid is supplied and a plurality of branch channels branching from the main channel are formed inside the turbulent flow forming member, the main channel is open at a center on an inlet side of the liquid, and the plurality of branch channels are open toward the turbulent flow forming space at symmetrical positions with respect to the center line of the slit.

2. The nozzle for applying a liquid film according to claim 1, wherein the space inside the top portion is also symmetrical with respect to a line orthogonal to the center line of the slit, and the plurality of branch channels of the turbulent flow forming member are opened on a line orthogonal to the center line of the slit or at symmetrical positions with respect to the line.

3. The nozzle for applying a liquid film according to claim 1, wherein the top portion has a hemispherical shape.

4. The nozzle for applying a liquid film according to claim 1, wherein the top portion has a conical shape or a truncated cone shape.

5. The nozzle for applying a liquid film according to claim 1, wherein the top portion has a pyramid shape or a truncated pyramid shape.

6. The nozzle for applying a liquid film according to claim 1, wherein a radius of a hemisphere of the hemispherical top portion is less than 2 mm.

7. The nozzle for applying a liquid film according to claim 1, wherein a width of the slit is 1/10 or less of a length of the slit.

8. The nozzle for applying a liquid film according to claim 1, wherein a width of the slit is 1/15 or less of a length of the slit.

9. The nozzle for applying a liquid film according to claim 1, wherein a width of the slit is 0.1 mm or more and 0.3 mm or less.

10. A method for applying a liquid film while moving the nozzle for applying a liquid film according to claim 1 at a constant speed in a direction orthogonal to a longitudinal direction of the slit at a height position where a liquid film discharged from the slit of the top portion reaches a surface of a coating target object.

11. A coating device of a liquid film, comprising:
the nozzle for applying a liquid film according to claim 1;
a gun for coating that has a distal end portion to which the nozzle is attached and supplies a liquid to the nozzle; and
a robot device that supports the gun for coating and moves the gun for coating at a constant speed in a direction orthogonal to a longitudinal direction of the slit at a height position where a liquid film discharged from the slit of the nozzle reaches a surface of a coating target object.

12. The coating device according to claim 11, wherein the gun for coating includes a valve device that turns on and off supply of the liquid to the nozzle.
